(19) United States
(12) Patent Application Publication
(10) Pub. No.: US 2004/0098137 A1
(43) Pub. Date: May 20, 2004

(54) Mirror display message board

(75) Inventor: Gerrit Hollemans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/295,672

(22) Filed: Nov. 15, 2002

(51) Int. Cl. G02F 1/29; G02B 26/08; G02B 7/182

(52) U.S. Cl. 700/1; 359/872; 359/298

(57) ABSTRACT

A mirrored electronic message board having a display portion and a recognition system. The recognition system has a processor, an identity input, and a memory. The identity input receives identity information relating to the identity of a user in proximity to the mirrored electronic message board. The processor analyzes the identity information to determine the identity of the user. The processor then utilizes the determined identity to retrieve data associated with the identified. user from the memory. The retrieved data is then provided to the display portion of the mirrored electronic message board for review by the identified user.

The present invention generally relates to a method and system for providing an easily assessable memo board and particularly relates to a method and device for providing a mirror-based memo board.

There are systems that provide an automobile rear view mirror having a mirrored surface and a display panel disposed behind the mirrored surface. In these systems, the display panel operates to provide an image that is visible through the mirrored surface when the display panel is actuated. For example, U.S. Pat. No. 6,412,959 to Tseng, the contents of which is incorporated herein as if set out in its entirety, shows such a rear view mirror. The display panel is utilized to display information that is received via an antenna or video camera. In this way, the rear view mirror may display automobile related information, such as shown in U.S. Pat. No. 6,106,121 to Buckley et al., the contents of which is incorporated herein as if set out in its entirety. In this patent, the rear view mirror having a matrix display behind a mirrored surface, may display vehicle control data such as vehicle speed, time, or radio station data. German Patent Publication No. DE 3720848 shows that vehicle turning information may be displayed on a rear view mirror. In yet another system shown in WIPO Patent Publication No. WO 02/49881 to Youn, the contents of which is incorporated herein as if set out in its entirety, a rear view mirror having a visible display, capable of displaying information such as a rear image taken by a rear facing camera, navigation map information, and television image signals.

However, each of these systems has many drawbacks in that each is limited to particular information and has no ability to provide information that is particularly adapted to a particular user.

U.S. Pat. No. 6,400,835 to Lemelson et al., the contents of which is incorporated herein as if set out in its entirety, shows such a security system that utilizes camera facing a rear view mirror. The camera obtains an image of a current driver utilizing the rear view mirror and compares the image to a stored image of allowable drivers. In the event that a match is found between the current driver and the stored allowable drivers, then the car is enabled for operation. The system may also provide personalization of various powered options of the vehicle such as seat position, cabin temperature, exterior mirror and window adjustments, angle of steering column and music selection or volume. Although this system is in effect personalized to the current driver, there is no disclosure that information is displayed in the rear view mirror and importantly, there is no personalization provided to features other than vehicle power options.

Accordingly, it is an object of the present invention to overcome the disadvantages of the prior art.

The invention provides system having a mirrored electronic message board having a display portion and a recognition system. The recognition system has a processor, an identity input, and a memory. The identity input receives identity information relating to the identity of a user in proximity to the mirrored electronic message board. The processor analyzes the identity information to determine the identity of the user. The processor then utilizes the determined identity to retrieve data associated with the identified user from the memory. The retrieved data is then provided to the display portion of the mirrored electronic message board for review by the identified user.

In one embodiment, the identity input is an image input, such as a camera input, for receiving images of the proximity around the message board. The processor utilizes an image recognition system for comparing a received image to a database of images of known users to identify the user. In an alternate embodiment, the system utilizes either voice or tactile input to determine the identity of the user.

These and other features of the present invention will become more apparent from the accompanying drawings and the following detailed description.

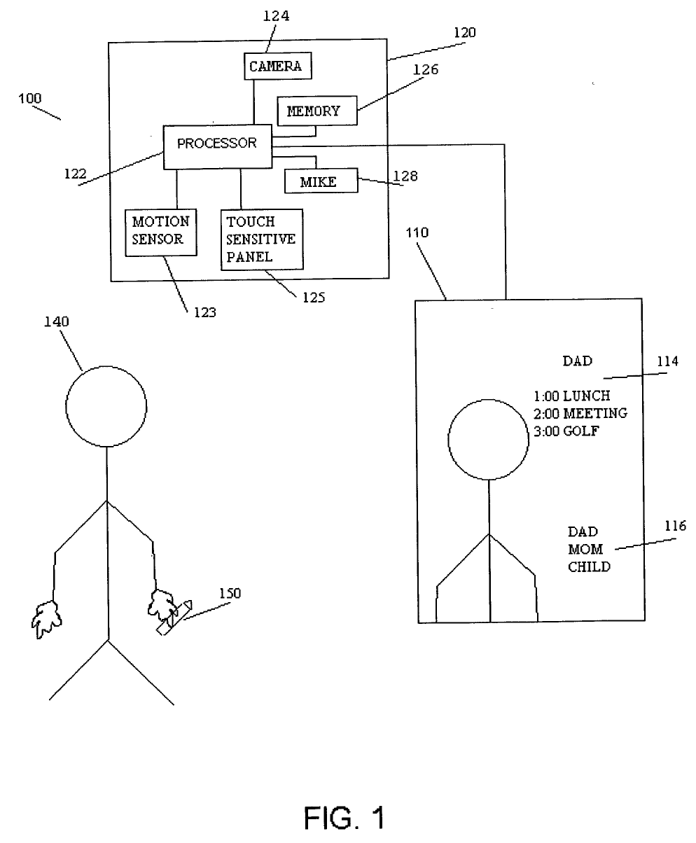

FIG. 1 shows an illustrative embodiment of a system including an illustrative user recognition system and a mirrored display surface in accordance with an embodiment of the present invention; and

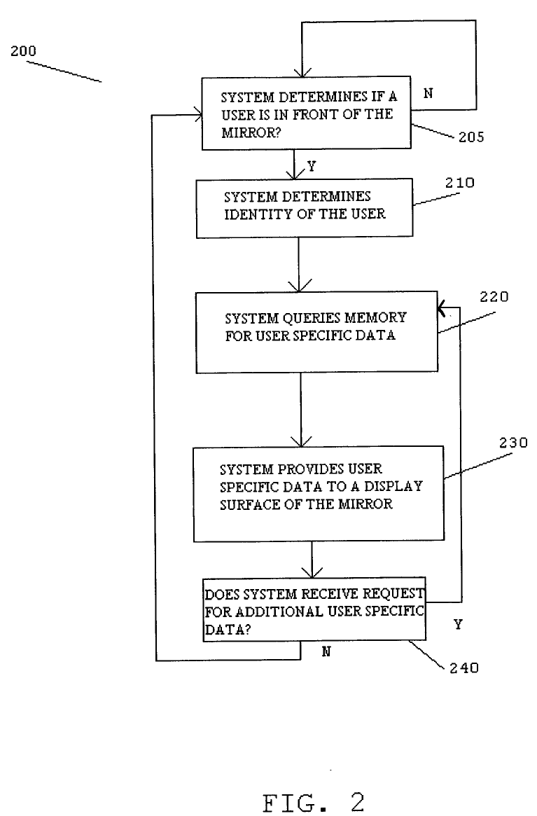

FIG. 2 shows a flow diagram illustrating operation of a system in accordance with an embodiment of the present invention.

FIG. 1 shows an illustrative system 100 in accordance with an embodiment of the present invention including a mirror 110, operatively coupled to a recognition system 120. To facilitate operation in accordance with an embodiment of the present invention, the recognition system 120 may comprise a processor 122 operatively coupled to an image input device, such as a camera 124. The camera 124 may be utilized to capture images of a user 140. The processor may also be operatively coupled to a memory 126, an audio input, such as microphone 128, a motion sensor 123, such as a passive infrared (PIR) motion sensor, and a touch sensitive panel 125, operationally positioned behind the mirror 110, for sensing tactile input applied to the mirror 110.

Further operation of the present invention will be described herein with regard to FIG. 2 that shows a flow diagram 200 in accordance with an embodiment of the present invention. As illustrated, during act 205 the system 100, utilizing the recognition system 120 determines if a user is positioned in proximity to the mirror 110, such as when the user is standing in front of the mirror 110. In the event that a user is not positioned in close proximity to the mirror 110, the recognition system 120 continuously processes act 205 until a user is detected in close proximity to the mirror 110.

There are many ways that are known in the art for the recognition system 120 to determine that a user has entered the proximity of the mirror 110. For example, the motion sensor 123 may be positioned to detect the motion of the user approaching the mirror 110. Alternatively or in conjunction therewith, the camera 124 may periodically process an image of the scene in front of the mirror 110. Presence of the user in front of the mirror 110 may be determined, for example, by producing a difference image between a current image and a reference image, such as a previous image or alternatively an image stored in the memory 126. However, it should be recognized by a person of ordinary skill in the art that there are many methods for utilizing the camera 124 to determine that a user is positioned in front of the mirror 110. Accordingly, each of these known methods should be understood to be within the scope of the present invention.

In one embodiment, at least a portion of the mirror 110 may contain a touch sensitive portion, such as a selection area 116, where the touch sensitive panel 125 determines the presence of an input. In operation, the touch sensitive panel 125 is operationally positioned with regard to the mirror 110 to sense user selection in the selection area. As described herein, the “touch sensitive panel” should be understood to encompass all known means for detecting a tactile user input including the user coming in to contact with, or in close proximity to a surface of the mirror 110. Tactile input upon a display surface is well known in the art, such as utilized for personal digital assistants (PDAs) and tablet-style personal computers. In accordance with an embodiment of the present invention, sensing of the user 140 coming in operational proximity to the selection area 116, such as when the user 140 utilizes a finger or a stylus 150 to touch a portion of the selection area 116, is sensed by the touch sensitive panel 125. This sensing by the touch sensitive panel 116 may be utilized to determine that the user 140 is positioned in front of the mirror 110.

In yet another embodiment, the microphone 122 may be utilized to capture audio indications from the user 140 to determine that the user 140 is positioned in front of the mirror 110. In any event, none of the above methods should be understood to impose particular limitations on other embodiment of the present invention unless specifically required by the appended claims.

Whichever method is utilized for determining that the user is positioned in proximity to the mirror 110, in act 210 the recognition system 120 determines the identity of the user. As would be apparent to a person of ordinary skill in the art, each of the above systems utilized to determine that the user 140 is in proximity to the mirror 110 may also be utilized to determine the identity of the user 140 concurrent with or subsequent to determining that the user is positioned in proximity to the mirror 110. Accordingly, the separation into separate acts 205 and 210 in FIG. 2 should not be interpreted as a necessary limitation to the present invention.

To determine the identity of the user 140, the processor 122 may compare a current image of the user 140, from the camera 124, to a database, stored in the memory 126, of images containing previously identified users. The processor 122 may alternatively utilize the microphone 128 to capture a voice input from the user 140. Similarly, the voice input may be compared to a database of previously identified voice inputs stored in the memory 126. In yet another embodiment, the user 140 may utilize the selection area 116 of the mirror 110 for the purpose of indicating the identity of the user 140 to the recognition system 120.

Regardless of how the user 140 is identified by the recognition system 120, in act 220 the processor 122 queries the memory 126 for data that is associated with the identified user 140. This data may include scheduling data, appointment data, contact data, required task completion data, or any other data that may be relevant to the identified user.

After the processor 122 retrieves the data that is associated with the identified user 140, then during act 230 the processor 122 provides the associated data to a display portion 114 of the mirror 110. To facilitate the user insuring that the recognition system 120 has properly identified the user 140, a portion of the display portion 114 may display the

determined identity of the user 140 In any event, after the processor 122 provides the associated data to the display portion 114 for some period of time, thereafter during act 240 the processor 122 determines whether the user has requested display of additional and/or alternate user specific data. Illustratively, the recognition system 120 may utilize the touch sensitive panel 125 or the microphone 128 to determine whether the user has requested the additional and/or alternate user specific data. In the event that the user has requested the additional and/or alternate user specific data, the processor 122 returns to act 220 to retrieve the additional and/or alternate user specific data and thereafter, operates as described above. In the event that the user makes no request for additional and/or alternate user specific data, then the processor 122 returns to act 205 and awaits a determination that an alternate user has entered the proximity of the mirror 110.

Finally, the above-discussion is intended to be merely illustrative of the present invention and should not be construed as limiting the appended claims to any particular embodiment or group of embodiments. For example, although the processor 120 is shown separate from the mirror 110, clearly both may be combined into a single unit. In addition, the processor may be a dedicated processor for performing in accordance with the present invention or may be a general-purpose processor wherein only one of many functions operate for performing in accordance with the present invention. The processor may operate utilizing a program portion, multiple program segments, or may be a hardware device utilizing a dedicated or multi-purpose integrated circuit. Each of the above systems utilized for identifying the presence and identity of the user may be utilized in conjunction with further systems. For example, the system 100 may utilize the camera 124 to determine the presence and identity of the user 140 and may thereafter, query the user 140, verbally through a speaker (not shown) or through the display portion 114, to confirm their identity utilizing the microphone input 128. The memory 126 may be comprised of one or more solid state memories, one or more optical memories, or any other combinations of known memory devices. Numerous alternate embodiments may be devised by those having ordinary skill in the art without departing from the spirit and scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function; and

e) each of the disclosed elements may be comprised of hardware portions (e.g., discrete electronic circuitry), software portions (e.g., computer programming), or any combination thereof.

What is claimed is:

1. An electronic message board comprising:
a mirror having a display portion; and
a recognition system operationally coupled to the display portion, wherein the recognition system is configured to identify an identity of a user in proximity to the mirror and is configured to provide data associated with the identified user to the display portion.

2. The electronic message board of claim 1, wherein the recognition system comprises:
an identity input;
a processor; and
a memory, wherein the processor is operationally coupled to the identity input and the memory and wherein the processor is configured to receive identity information from the identity input, determine the identity of the user, and retrieve the data associated with the identified user.

3. The electronic message board of claim 2, wherein the identity input is a camera input configured to receive images of the proximity around the mirror and the processor is configured to compare images stored in the memory of known users to the received images to determine the identity of the user.

4. The electronic message board of claim 2, wherein the identity input is an audio input configured to receive audio data originating from the proximity around the mirror and the processor is configured to compare audio signatures stored in the memory of known users to the received audio data to determine the identity of the user.

5. The electronic message board of claim 2, wherein the mirror comprises a selection area and wherein the identity input is a touch sensitive input configured to receive user identity selection.

6. The electronic message board of claim 2, wherein the memory is configured to store identity information for a plurality of users and corresponding data associated with each of the plurality of users.

7. An electronic method of providing data corresponding to a particular one of a plurality of users, the method comprising the acts of:
identifying a user in close proximity to a mirrored electronic message board;
retrieving data associated with the identified user; and
displaying the data associated with the identified user on the mirrored electronic message board.
